(19) United States
(12) Patent Application Publication
(10) Pub. No.: US 2026/0120488 A1
(43) Pub. Date: Apr. 30, 2026

(54) IMAGE ANNOTATION USING LOCALIZED EMBEDDINGS

(71) Applicant: Walmart Apollo, LLC, Bentonville, AR (US)

(72) Inventors: Ravi Kumar Dalal, Flower Mound, TX (US); Michael Aaron Garner, Centerton, AR (US)

(21) Appl. No.: 18/925,395

(22) Filed: Oct. 24, 2024

(51) Int. Cl. G06V 20/70; G06V 10/762

(52) U.S. Cl. CPC G06V 20/70; G06V 10/762; G06V 2201/07

(57) ABSTRACT

Example implementations relate to image annotation. In an example, a reference image is received and at least one embedding representative of at least one feature of an annotated object is generated. A dimension size of the embedding, a vertical position maximum, and a horizontal position maximum of the reference image is generated. A vertical position encoding and a horizontal position encoding are determined for the annotated object. A shape of the position encodings is based on the positional maximums of the reference image and the dimension size of the embedding. A first cluster centroid is generated by combining the embedding and the position encodings. An unannotated object is identified in image data based on a comparison of the first cluster centroid and a second cluster centroid generated for the unannotated object.

### TECHNICAL FIELD

This application relates generally to image annotation, and more particularly, to generating localized embeddings for annotating additional elements.

### BACKGROUND

Image annotation includes a process of adding metadata or labels to an image that provide additional information about the image contents. Metadata can include various types of information, such as object bounding boxes, segmentation masks, key points, or semantic labels. Metadata may be used to easily identify aspects of a presented image, such as identifying objects or other properties within an image, locations of the objects within an image, or understanding of the image at a pixel level.

Current systems require labelled data for supervised computer vision tasks, such as training of a machine learning model for vision tasks. Generation of labelled data, such as annotated data or metadata-enriched images, is typically a manual, time consuming task. Although some existing systems utilize processes that may reduce the time spent creating the labelling data, the resulting labelling data in such systems is unreliable. This results in more work for the annotator to ensure the labelling data is accurate.

### BRIEF DESCRIPTION OF THE DRAWINGS

Various examples will be described below with reference to the following figures.

FIG. 1 depicts an example system for generating localized embeddings from a reference image and generating annotations using the localized embeddings, in accordance with some embodiments.

FIG. 2 depicts a block diagram illustrating an example of a reference image having a coordinate grid, in accordance with some embodiments.

FIG. 3 is a flow diagram depicting an example method for annotating an image using localized embeddings, in accordance with some embodiments.

FIG. 4 depicts example system for image annotation that includes a machine-readable medium encoded with example instructions executable by processing resource, in accordance with some embodiments.

FIG. 5 depicts a block diagram of a computing device, in accordance with some embodiments.

FIG. 6 depicts an artificial neural network, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system for generating localized embeddings and annotating image data using the localized embeddings is disclosed. The system includes a processor and a non-transitory memory storing instructions. The instructions, when executed, cause the processor to receive a reference image including at least one annotated object, generate at least one embedding representative of the at least one annotated object, and determine a dimension size of the at least one embedding, a vertical position maximum (e.g., a y_max) of the reference image, and a horizontal position maximum (e.g., an x_max) of the reference image. A vertical position encoding (e.g., a y_positional encoding) and a horizontal position encoding (e.g., an x_positional encoding) for the at least one annotated object of the reference image is determined. A shape of the vertical position encoding is based on the vertical position maximum of the reference image and the dimension size of the embedding and a shape of the horizontal position encoding is based on the horizontal position maximum of the reference image and the dimension size of the embedding. A cluster center for the at least one object is generated by combining the at least one embedding, the vertical position encoding, and the horizontal position encoding. The instructions, when executed, further cause the processor to identify an unannotated object in image data based on a comparison of the first cluster centroid and a second cluster centroid generated for the unannotated object.

In various embodiments, a computer implemented method for generating localized embeddings and annotating image data using the localized embeddings is disclosed. The computer-implemented method includes steps of receiving a reference image including at least one annotated object, generating at least one embedding representative of the at least one annotated object in the reference image, determining a dimension size of the at least one embedding, a vertical position maximum (e.g., a y_max) of the reference image, and a horizontal position maximum (e.g., an x_max) of the reference image, and determining a vertical position encoding (e.g., a y_positional encoding) and a horizontal position encoding (e.g., an x_positional encoding) for the at least one annotated object of the reference image. A shape of the vertical position encoding is based on the vertical position maximum of the reference and the dimension size of the at least one embedding and a shape of the horizontal position encoding is based on the horizontal position maximum of the reference image and the dimension size of the at least one embedding. The method further includes steps of generating a cluster center embedding for the at least one object by combining the at least one embedding, the vertical position encoding, and the horizontal position encoding. The method further includes a step of identifying an unannotated object in image data based on a comparison of the first cluster centroid and a second cluster centroid generated for the unannotated object.

In various embodiments, a non-transitory computer readable medium having instructions stored thereon is disclosed. The instructions, when executed by a processor, cause a device to perform operations including receiving a reference image including at least one annotated object. The instructions further cause the device to perform operations including generating at least one embedding representative of the at least one object, determining a dimension size of the at least one embedding, a vertical position maximum (e.g., a y_max) of the reference image, and a horizontal position maximum (e.g., an x_max) of the reference image, and determining a vertical position encoding (e.g., a y_positional encoding) and a horizontal position encoding (e.g., an x_positional encoding) for the at least one annotated object of the reference image. A shape of the vertical position encoding is based on the vertical position maximum of the reference and the dimension size of the at least one embedding and a shape of the horizontal position encoding is based on the horizontal position maximum of the reference image and the dimension size of the at least one embedding. The instructions further cause the device to perform operations including generating a first cluster center embedding for the at least one object by combining the at least one embedding, the vertical position encoding, and the horizontal position encoding and identifying an unannotated object in image data based on a comparison of the first cluster centroid and a second cluster centroid generated for the unannotated object.

Furthermore, in the following, various embodiments are described with respect to methods and systems for generating localized embeddings from a reference image that may be subsequently used to annotate an unannotated portion of a dataset. In various embodiments, a dimension size of an embedding representative of an object in the reference image, a y_max of a reference image, and an x_max of the reference image determine the shape and size of positional encodings of a selected object. The positional encodings may comprise a y_positional encoding and an x_positional encoding for a selected object of the reference image. The positional encodings may be determined following a given distribution (e.g., a normal distribution, a gaussian distribution, a uniform distribution, etc.) along the x axis and y axis of the reference image. In some embodiments, a convolutional neural network (CNN) feature extractor model is applied to the y_positional encoding and x_positional encoding to generate feature embeddings representative of a plurality of features of the object (e.g., textures, edges, shapes, objects, patterns, universal product codes (UPCs), global trade item numbers (GTIN), etc.). In some embodiments, the embeddings, y_positional encoding, and x_positional encoding are combined to generate a cluster center embedding for an object. In some embodiments, an unannotated object in image data, such as the reference image or a second image, is identified based on a comparison of the first cluster centroid and a second cluster centroid generated for the unannotated object.

In some embodiments, systems and methods for image annotation include one or more trained machine learning models. The one or more machine learning models may include, for example, a CNN model. In particular, by training based on training data the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

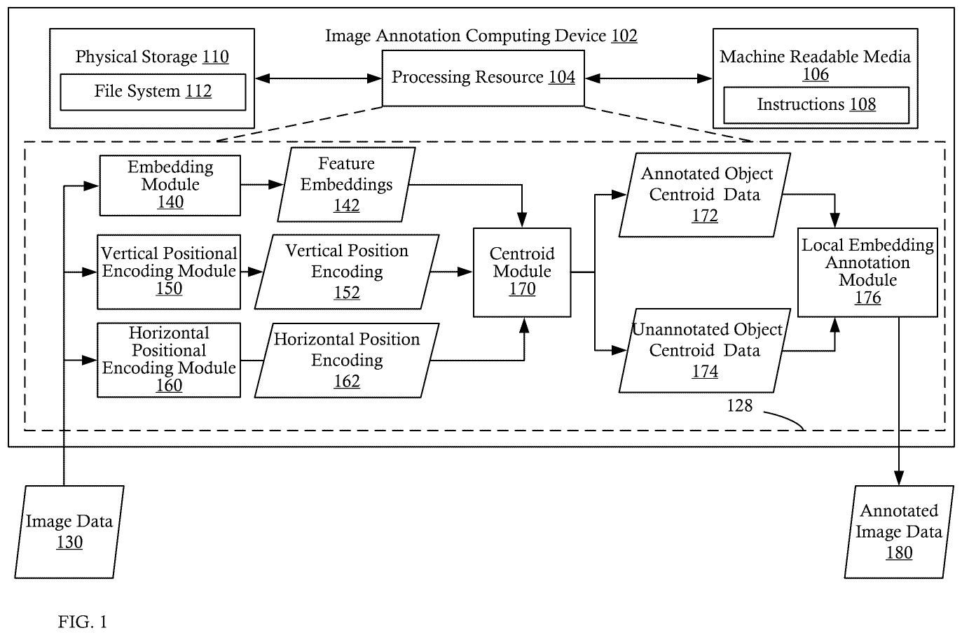

FIG. 1 depicts an example system 100 for generating localized embeddings from a reference image and generating annotates using the localized embeddings, in accordance with some embodiments. The system 100 includes an image annotation computing device 102 that generates localized embeddings from a reference image and subsequently utilizes the localized embeddings to annotate one or more additional objects in image data by identifying objects having corresponding localized embeddings. The image annotation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The image annotation computing device 102 includes a non-transitory machine readable media 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (e.g., programming or software code) stored on machine readable media 106 to perform functions of the image annotation computing device 102, such as receiving a reference image, generating a cluster centroid for each object annotated in the reference image, and identifying unannotated objects in image data based on cluster centroids of the corresponding unannotated objects. The instructions 108 may include instructions for implementing one or more models. In some embodiments, and as will be described further herein below, the image annotation computing device 102 may execute one or more models, processes, or algorithms, such as a CNN model.

The image annotation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the image annotation computing device 102. In some implementations, physical storage 110 may be accessed as a block storage device.

In some cases, the image annotation computing device 102 may also include a local file system 112 that may be implemented as a layer on top of the physical storage 110. For example, an operating system may be executing on the image annotation computing device 102 (by virtue of the processing resource 104 executing certain instructions 108 related to the operating system) and the operating system may provide a file system 112 to store data on the physical storage 110.

The image annotation computing device 102 may be in communication with one or more additional devices over one or more network channels. For example, in various embodiments, the image annotation computing device 102 may be in communication with one or more a cloud-based engines or servers, such as one or more processing devices that may be provisioned for use (e.g., a web server, a processing server, etc.), a database, a workstation, and/or any other suitable system or device.

In some embodiments, the image annotation computing device 102 implements one or more processes, such as an annotation process 128. The annotation process 128 receives image data 130. The image data 130 may include background image data and one or more objects positioned over or within the background image data. For example, the image data 130 may be, but is not limited to, a two dimensional (“2D”) image, a three dimensional (“3D”) image, a selected frame of a 2D video, a selected frame of a 3D video, etc. In some embodiments, the image data 130 may include, but is not limited to, various file formats such as, JPG, PNG, BMP, PDF, TIFF, GIF, EPS, RAW, etc. In some embodiments, the image data 130 includes image data representative of a fixture (e.g., shelf, endcap, pallet, etc.) having one or more objects (e.g., items) supported thereon.

In some embodiments, the image data 130 may include one or more annotations identifying one or more objects or object clusters in the image. Image data 130 including one or more annotations may be referred to herein as a reference image. For example, a reference image may include annotation data identifying an object, a minimum (or first) x position for the object, a minimum (or first) y position for the object, a maximum (or second) x position for the object, and a maximum (or second) y position for the object. The minimum x position, minimum y position, maximum x position, and maximum y position define a bounding box that encompasses a position of the corresponding object within the image. In some embodiments, the image data 130 includes a dimension size definition for an object (or an object embedding) in a reference image.

A position of one or more objects, such as one or more annotated objects (e.g., objects in the image data 130 having annotation data associated therewith) or one or more unannotated objects (e.g., objects in the image data 130 without annotations) may be determined. The position of one or more objects may include a minimum vertical position of the object (referred to herein as a y_min of the object), a maximum vertical position of the object (referred to herein as a y_max of the object), a minimum horizontal position of the object (referred to herein as an x_min of the object), or a maximum horizontal position of the object (referred to herein as an x_max of the object). In some embodiments, a position of an object is identified using one or more computer vision processes, such as, for example, an object recognition process. The object may be selected from a plurality of objects in the image data 130. The object may include a plurality of features (e.g. textures, edges, shapes, objects, patterns, universal product codes (UPCs), and global trade item numbers GTIN)) that distinguishes the object from one or more other objects in the image data 130. In some embodiments, the object includes a cluster of identical or substantially similar products (e.g., a cluster of the same item) that have the same features. The image data 130 may be provided to a feature extractor embedding module 140, a vertical position encoding module 150, and/or a horizontal position encoding module 160 simultaneously and/or sequentially in any potential combination.

In some embodiments, the feature extractor embedding module 140 receives object image data for a selected object in the image data 130 and generates at least one feature embedding 142 for the corresponding object. The at least one feature embedding 142 includes a vector embedding that characterizes one or more of a texture, edges, shape, pattern, universal product codes (UPCs), global trade item numbers (GTIN), and/or other features of a selected object in the image data 130. The at least one feature embedding 142 may be generated by any suitable image embedding process based on a portion of the image data 130 and the corresponding annotation data. For example, in some embodiments, the at least one feature embedding 142 is generated by a convolution neural network (CNN) based embedding model.

In some embodiments, the vertical position encoding module 150 receives object image data for the selected object in the image data 130 and implements a vector encoding process to output a vertical (e.g., y-level) position encoding 152 (referred to herein as a y_positional encoding), such as a vertical position encoding embedding (referred to herein as a y_positional encoding embedding) representing a position on the y axis of the object within the image data 130. The vertical position encoding 152 is determined according to a selected distribution of the vertical space within the image data 130 (e.g., a normal distribution, a gaussian distribution, a uniform distribution, etc.). In some embodiments, a shape (e.g., dimensions) of the vertical position encoding 152 is determined as [Ymax_image_size, Dimension Size of Feature Embedding], where Ymax_image_size is determined from the image data 130, for example, based on object recognition processes, bounding box processes, or other computer object identification processes. In some embodiments, the vertical position encoding 152 is the vector encoding of a y_positional encoding of the selected object of a plurality of objects in the image data 130.

In some embodiments, the horizontal position encoding module 160 receives object image data for the selected object in the image data 130 and implements a vector encoding process to output a horizontal (e.g., x level) position encoding 162 (referred to herein as an x_positional encoding), such as a horizontal position encoding embedding (referred to herein as an x_positional encoding embedding). The horizontal position encoding 162 represents a position on the x axis of the selected object within the image data 130. The horizontal position encoding 162 is determined according to a selected distribution of the horizontal space within the image data 130 (e.g., a normal distribution, a gaussian distribution, a uniform distribution, etc.). In some embodiments, a shape (e.g., dimensions) of the horizontal position encoding embedding 162 is determined as [Xmax_image_size, Dimension Size of Feature Embedding], where Xmax_image_size is determined from the image data 130. In some embodiments, the horizontal position encoding embedding 162 is the vector encoding of an x_positional encoding of the selected object of a plurality of objects in the image data 130.

In some embodiments, the image annotation computing device 102 device further includes a centroid module 170 that receives the at least one feature embedding 142, the vertical position encoding 152, the horizontal position encoding 162, and a corresponding object annotation (if present) and outputs centroid data 172, 174. For example, where the vertical position encoding 152 and the horizontal position encoding 162 include encoding embeddings, the at least one feature embedding 142, the vertical position encoding 152, and the horizontal position encoding 162 may be combined (e.g., concatenated, averaged, etc.) to generate the centroid data 172, 174. For example, where the vertical position encoding 152 and the horizontal position encoding 162 include position encoding embeddings, the at least one feature embedding 142, the vertical position encoding 152, and the horizontal position encoding 162 may be concatenated. The centroid data 172, 174 represents a cluster center for the selected object within the image data 130. The cluster center embeddings of centroid data 172, 174 of the selected object may be representative of the location of the selected object in the image data 130.

In some embodiments, the centroid module 170 generates annotated object centroid data 172 and unannotated object centroid data 174. The annotated object centroid data 172 includes centroid data for annotated, e.g., identified, objects included in the image data 130. Similarly, the unannotated object centroid data 174 includes centroid data for unannotated objects in the image data 130. In some embodiments, the object centroid data 172, 174 includes object-specific center embeddings representative of a center point (e.g., center x, y coordinates) for an object in the reference image. In some embodiments, annotated object centroid data 172 may be generated from a first set of image data containing one or more annotations and unannotated object centroid data 174 may be generated from a second set of image data without annotations. As another example, in some embodiments, annotated object centroid data 172 may be generated for a first object including an annotation in image data 130 and unannotated object centroid data 174 may be generated for a second object without an annotation in image data 130.

The annotated object centroid data 172 and the unannotated object centroid data 174 are provided to a local embedding annotation module 176. The local embedding annotation module 176 compares each instance of unannotated object centroid data 174 to each instance of annotated object centroid data 172 to identify the most similar instance of annotated object centroid data 172. For example, the local embedding annotation module 176 may determine a similarity score representative of the similarity of unannotated object centroid data 174 for an unannotated object to annotated object centroid data 172 for each annotated object in the image data 130. The local embedding annotation module 176 generates annotated image data 180 including annotations identifying a previously unannotated object as a corresponding annotated object having the most similar annotated object centroid data 172. In some embodiments, annotated object centroid data 172 is generated using an annotated reference image and unannotated object centroid data 174 is generated using a second image. In some embodiments, the annotated image data 180 may be provided as an input (e.g., as image data 130) to one or more subsequent operations of the annotation process 128.

In some embodiments, the localized embedding generation and annotation process 128 is a single-shot, localized embedding annotation process. The localized embedding generation and annotation process 128 receives at least one reference image (e.g., image data 130 including one or more object annotations) and generates a set of annotated object centroid data 172 for each annotated object in the reference image. The localized embedding generation and annotation process 128 subsequently receives a set of unannotated images and annotates one or more objects in each unannotated image based on comparisons of annotated object centroid data 172 generated from the at least one reference image and unannotated object centroid data 174 generated for each object in the unannotated image(s). The reference image and each of the unannotated images are processed as discussed above.

In some embodiments, annotations determined for an initially unannotated image may be used for annotation of subsequent images. For example, in some embodiments, a first reference image may be received and a set of annotated object centroid data 172 may be generated from the first reference image and used to annotate a first unannotated image to generate a second reference image (e.g., the first unannotated image modified to include one or more annotations). Subsequently, the second reference image may be received and a set of annotated object centroid data 172 may be generated for the second reference image and used to annotate a second unannotated image. It will be appreciated that the set of annotated centroid data 172 may be a fixed set (e.g., generated only from one or more initial reference images), an expandable set (e.g., modified to include additional centroids after labelling of unannotated object centroid data 174), or a changing set (e.g., modified to include most recent annotated object centroid data 172 from a most recently processed reference image).

In some embodiments, annotated image data, e.g., the reference image and subsequently annotated objects or images generated based on the annotated object centroid data 172, may be provided for use in further computer vision tasks. For example, the annotated objects or images may be used to train one or more computer vision models, such as object recognition models, object extraction models, etc. As another example, the annotated objects or images may be provided as a validation set, a test set, or a process set for one or more computer visional models.

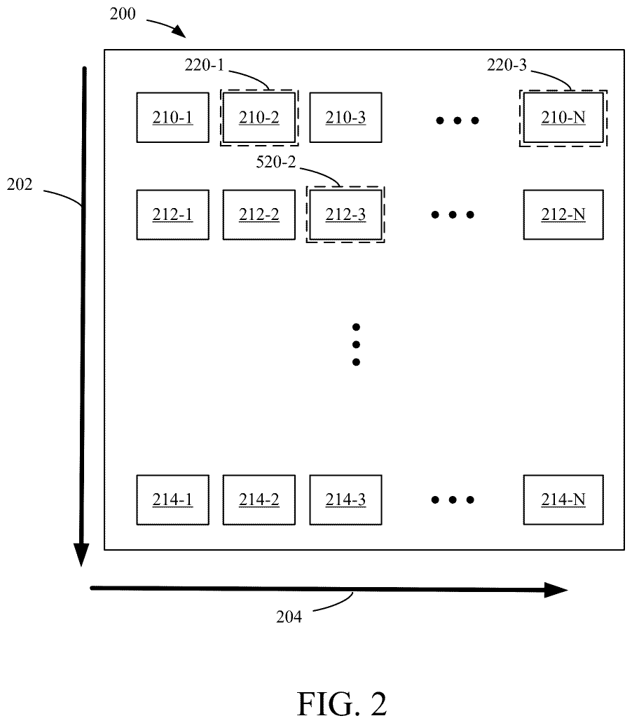

FIG. 2 depicts a block diagram illustrating an example of an image 200 having a coordinate grid, in accordance with some embodiments. A plurality of objects 210-1 to 210-N, 212-1 to 212-N, 214-1 to 214-N (collectively objects 210-214) are arranged within a distribution of vertical positions on a y-axis 202 and horizontal positions on an x-axis 204. Each of the objects 210-214 may be identified by a bounding box, such as bounding boxes 220-1 to 220-3, generated according to one or more object identification processes and/or based on annotation data associated with the image 200. The y-axis 202 positions span the vertical length of the annotated reference image 200 and the x-axis 204 positions span the horizontal length of the image 200. For example, in the illustrated embodiment, a y-axis position may extend from a minimum y-position (e.g., y_min) to a maximum y-position (e.g., y_max) and an x-axis position may extend from a minimum x-position (e.g., x_min) to a maximum x-position (e.g., x_max). The total quantity of positional encodings for the coordinate grid may be represented by a value of N×M, where N is a maximum y position of the image 200 and M is a maximum x position of the image 200.

The image 200 may include annotation data for one or more objects, e.g., may be a reference image. As discussed above with respect to FIG. 1, sets of object centroid data may be determined for both annotated objects and unannotated objects. Object centroid data for an unannotated object, such as object 212-3, is compared to object centroid data for each annotated object, e.g., such as objects 210-2, and a label applied to unannotated object 212-3 based on the annotated object centroid data that is most similar to the object centroid data of unannotated object 212-3.

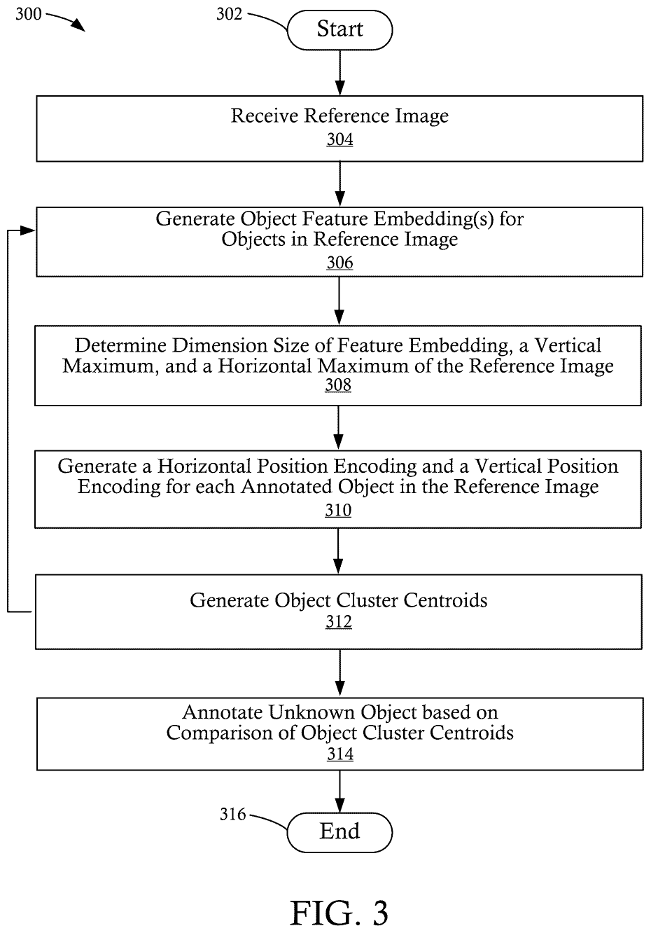

FIG. 3 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 3 may be implemented in the form of executable instructions stored on a machine readable media and executed by a processing resource and/or in the form of electronic circuitry. For example, aspects of the method may be described below as being performed by an annotation system, an example of which may be the annotation process 128 running on a hardware processing resource 104 of the image annotation computing device 102 described above. Additionally, other aspects of the method described below may be described with reference to other elements shown in FIG. 1 for non-limiting illustration purposes.

FIG. 3 is a flow diagram depicting an example method 300 for annotating an image using localized embeddings, in accordance with some embodiments. Method 300 starts at block 302 and continues to block 304, where one or more reference images are received. As discussed above, a reference image may depict any type of background and one or more objects, may be an image or frame of a video, may be provided in any suitable format, and may include have annotation data associated therewith. The reference image may be comprised of image data. The reference image includes annotation data and/or image data that can be transmitted and received by one or more modules of the image annotation computing device 102, as discussed above.

At block 306, at least one feature embedding is generated for one or more objects included in the reference image. The feature embeddings may be generated by a feature extractor embedding model, such as a CNN model. The feature embeddings represent one or more features of the one or more objects. For example, a selected object may be an item of a plurality of items, comprising a unique UPC code, on a planogram and included in the reference image. The feature extractor embedding model may generate a vector embedding representative of the texture, edges, shape, patterns, or any other visually distinguishing feature of a selected object. In some embodiments, distinguishing each item from the plurality of items in the reference image may allow for training and implementation of computer vision models for use in computer vision tasks such as item identification, inventory identification, space optimization, space allocation, quality control, etc. Each of the one or more objects may be an annotated object (e.g., associate with annotation data of the reference image) or an unannotated object.

At block 308, a dimension size of an embedding, a vertical maximum (e.g., y_max), and a horizontal maximum (e.g., x_max) for the reference image are determined. The dimension size of the embedding may be provided in a plurality of dimensionalities. In some embodiments, the dimension size is determined by an embedding module used to generate an object image embedding for a selected object. In some embodiments, the size of the embedding is preset by a user. For example, the set embedding size may be a minimum of 128, any multiple of 128 (e.g., 128, 256, 512, 1024, etc.), a max of 2048 and/or any other suitable size. In some embodiments, once the dimension size of the embedding is determined, a y_max and an x_max may be calculated, for example, based on a resolution of the reference image or based on a quantity of columns and/or rows in the reference image. In some embodiments, the y_max and x_max of the reference image may be determined by a quantity of embeddings that can fit in a vertical length and horizontal length of the reference image, respectively. As one non-limiting example, a calculated dimension size for generating an embedding (e.g., a minimum size of an object that may be included within an reference image) may be determined to be a size m, a vertical length of the reference image may be 50*m, and the horizontal length of the reference image may be 30*m, resulting in a y_max of 50 and an x_max of 30, with an overall coordinate grid of 150 embeddings that may be calculated and assigned for the reference image. In other embodiments, the y_max and/or the x_max may be determined independent of the dimensional size of an embedding. After the dimension size of the embedding, the vertical maximum, and the horizontal maximum are determined, a coordinate grid of positional encodings may be generated for the entire area of the reference image.

At block 310, a vertical position encoding and a horizontal position encoding are generated for each object identified in the reference image. The corresponding vertical position encoding and the horizontal position encoding may be determined by a vertical position encoding module and a horizontal position encoding module, respectively, for a selected object. The vertical position encoding module and the horizontal position encoding module include one or more positional embedding models that convert one or more of a minimum x position, a minimum y position, a maximum x position, a maximum y position, or an area associated with an object into an embedding representation. In some embodiments, a positional embedding model receives reference image data including a dimension size definition for generated embeddings, a vertical maximum of the reference image, a horizontal maximum of the reference image, and a selected object (e.g., coordinates for a selected object, bounding box for a selected object, etc.). As described above, the vertical position encoding and the horizontal position encoding of the selected object have a shape that is based on at least the vertical maximum and horizontal maximum, respectively, and the determined dimension size of the embedding. For example, the vertical position encoding and horizontal position encoding of the selected object may represent a position on the coordinate grid of positional encodings generated in block 208.

At block 312, an object-specific cluster centroid is generated for each object in the reference image. As described above, the centroid module receives the y_positional encoding and x_positional encoding determined at block 310 and the set of feature embeddings generated at block 306. The object-specific cluster centroid may include a bounding box (e.g., a defined around the selected object so that it may be classified, tagged, or labelled) such that the center of the bounding box coordinates are the vertical position encoding and horizontal position encoding of the corresponding object. In some embodiments, as described above, a centroid module generates object-specific cluster centroids by combining the feature embeddings, the vertical position encoding, and the horizontal position encoding. In some examples, the object-specific cluster centroid classifies an object by one or more specific feature of the feature embedding. Classification of the selected object by one or more specific features further distinguishes the selected item from the plurality of items and may further enable computer vision tasks, organization of the reference image, or corresponding annotations. The method then returns to block 306 until an object-specific cluster centroid has been generated for each object of a plurality of objects and is mapped to a position of the coordinate grid of positional encodings.

At block 314, a label is applied to an unannotated object of the plurality of objects by comparing similarity scores of each object-specific cluster centroid generated for each annotated object in the reference image (or generated from a separate reference image). After the object-specific cluster centroid of the unannotated object is generated, the object-specific cluster centroid of the unannotated object is compared to each object-specific cluster centroid of the annotated objects. For each comparison, a similarity score is generated. Once the object-specific cluster centroid of the unannotated object is compared to each object-specific cluster centroid of the annotated objects, the object-specific cluster centroid of the unannotated object is labelled (e.g., annotated) as the same object as the corresponding annotated object with a highest similarity score. Comparing the object-specific cluster centroid of an unannotated object with every object-specific cluster centroid of annotated objects increases annotation speed and reliability of annotations, labeling, and/or assignment of the object data within the reference image. At block 316, the method 300 ends.

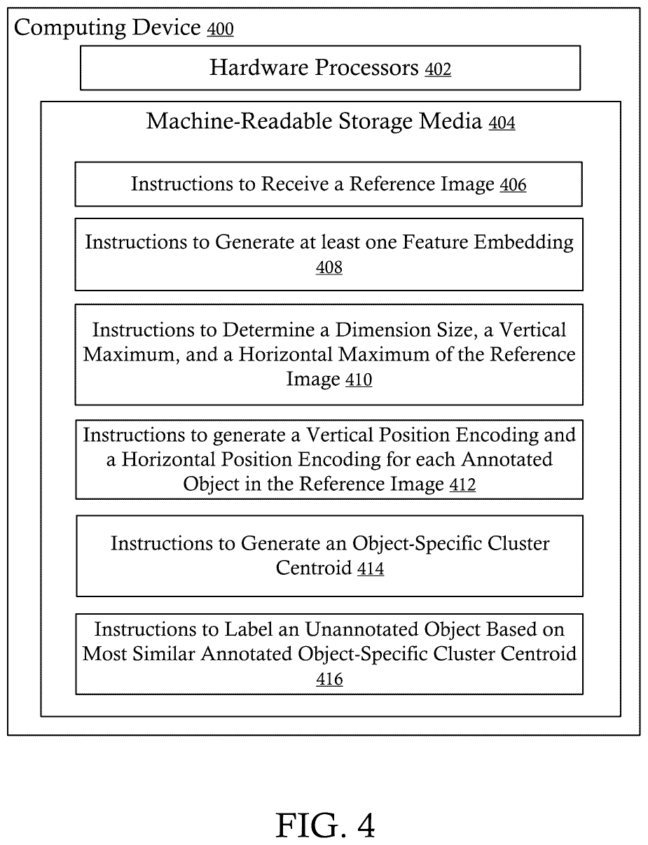

FIG. 4 depicts an example system 400 for image annotation that include a machine readable media 404 encoded with example instructions executable by processing resource 402. In some implementations the system 400 may be useful for implementing aspects of the system 100 of FIG. 1 or performing the aspects of method 300 of FIG. 3. For example, the instructions encoded on machine readable media 404 may be included in instructions 108 of FIG. 1. In some implementations, functionality described with respect to FIG. 1 may be included in the instructions encoded on machine readable media 404.

The processing resource 402 may include a microcontroller, a microprocessor, central processing unit core(s), an ASIC, an FPGA, and/or other hardware device suitable for retrieval and/or execution of instructions from the machine readable media 404 to perform functions related to various examples. Additionally or alternatively, the processing resource 402 may include or be coupled to electronic circuitry or dedicated logic for performing some or all of the functionality of the instructions described herein.

The machine readable media 404 may be any medium suitable for storing executable instructions, such as RAM, ROM, EEPROM, flash memory, a hard disk drive, an optical disc, or the like. In some example implementations, the machine readable media 404 may be a tangible, non-transitory medium. The machine readable media 404 may be disposed within the system 400 in which case the executable instructions may be deemed installed or embedded on the system. Alternatively, the machine readable media 404 may be a portable (e.g., external) storage medium, and may be part of an installation package.

As described further herein below, the machine readable media 404 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 4.

The machine readable media 404 includes instructions 406-416. Instructions 406, when executed, cause the processing resource 402 to receive a reference image. Instructions 408, when executed, cause the processing resource 402 to generate at least one feature embedding for each object in a reference image. Instructions 410, when executed, cause the processing resource 402 to determine a dimension size, a y_max, and an x_max of the reference image. Instructions 412, when executed, cause the processing resource 402 to determine a y_positional encoding and x_positional encoding for each object in the reference image. Instructions 414, when executed, cause the processing resource 402 to generate an object-specific centroid cluster for a selected object of the plurality of objects of the reference image. Instructions 416, when executed, cause the processing resource 402 to label an unannotated object based on a most similar annotated object-specific cluster centroid, e.g., based on a highest similarity score of the object-specific cluster centroid of the unannotated object and each of the annotated object-specific cluster centroids for each of annotated object.

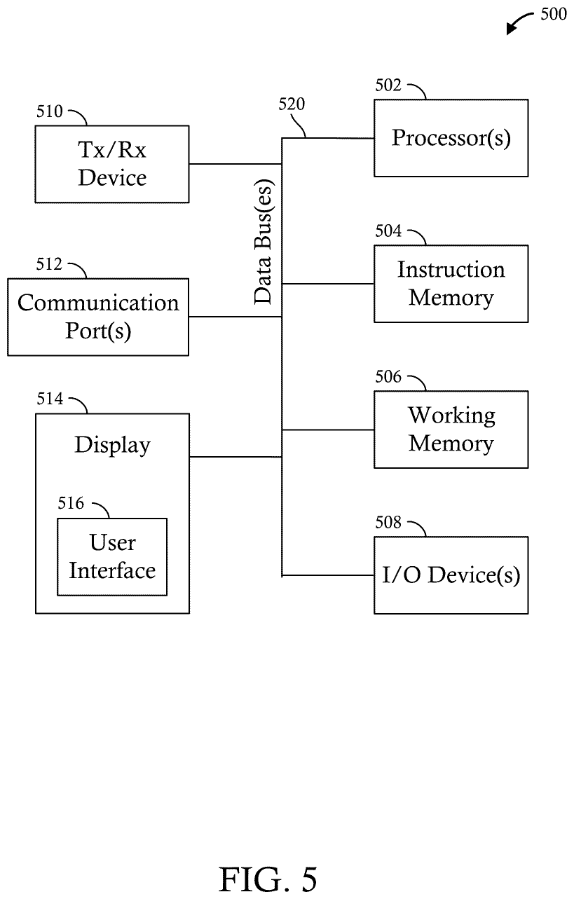

FIG. 5 illustrates a block diagram of a computing device 500, in accordance with some embodiments. Although FIG. 5 is described with respect to certain components shown therein, it will be appreciated that the elements of the computing device 500 may be combined, omitted, and/or replicated. In addition, it will be appreciated that additional elements other than those illustrated in FIG. 5 may be added to the computing device.

As shown in FIG. 5, the computing device 500 may include one or more processing resources 502, instruction memory 504, working memory 506, input/output devices 508, transceiver 510, communication port(s) 512, display 514, and/or any other suitable elements each operatively coupled to one or more data buses 520. The data buses 520 allow for communication among the various components. The data buses 520 may include wired, or wireless, communication channels.

The one or more processing resources 502 may include any processing circuitry operable to control operations of the computing device 500. In some embodiments, the one or more processing resources 502 include one or more distinct processors, each having one or more cores (e.g., processing circuits). Each of the distinct processors may have the same or different structure. The one or more processing resources 502 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 502 may also be implemented by a controller, a microcontroller, an application specific integrated circuit (ASIC), a field programmable gate array (FPGA), a programmable logic device (PLD), etc.

In some embodiments, the one or more processing resources 502 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 504 may store instructions that are accessed (e.g., read) and executed by at least one of the one or more processing resources 502. For example, the instruction memory 504 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 502 may perform a certain function or operation by executing code, stored on the instruction memory 504, embodying the function or operation. For example, the one or more processing resources 502 may execute code stored in the instruction memory 504 to perform one or more of any function, method, or operation disclosed herein.

Additionally, the one or more processing resources 502 may store data to, and read data from, the working memory 506. For example, the one or more processing resources 502 may store a working set of instructions to the working memory 506, such as instructions loaded from the instruction memory 504. The one or more processing resources 502 may also use the working memory 506 to store dynamic data created during one or more operations. The working memory 506 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 504 and working memory 506, it will be appreciated that the computing device 500 may include a single memory unit that operates as both instruction memory and working memory. Further, although embodiments are discussed herein including non-volatile memory, it will be appreciated that computing device 500 may include volatile memory components in addition to at least one non-volatile memory component.

In some embodiments, the instruction memory 504 and/or the working memory 506 includes an instruction set, in the form of a file for executing various methods, such as methods for image annotation through implementation of localized embeddings, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NOSQL, Rust, Perl, etc. In some embodiments a compiler or interpreter converts the instruction set into machine executable code for execution by the one or more processing resources 52.

The input/output devices 508 may include any suitable device that allows for data input or output. For example, the input/output devices 508 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 510 and/or the communication port(s) 512 allow for communication with a network. For example, if a communication network is a cellular network, the transceiver 510 allows communications with the cellular network. In some embodiments, the transceiver 510 is selected based on the type of the communication network the computing device 500 will be operating in. The one or more processing resources 502 are operable to receive data from, or send data to, a network via the transceiver 510.

The communication port(s) 512 may include any suitable hardware, software, and/or combination of hardware and software that is capable of coupling the computing device 500 to one or more networks and/or additional devices. The communication port(s) 512 may be arranged to operate with any suitable technique for controlling information signals using a desired set of communications protocols, services, or operating procedures. The communication port(s) 512 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 512 allows for the programming of executable instructions in the instruction memory 504. In some embodiments, the communication port(s) 512 allow for the transfer (e.g., uploading or downloading) of data, such as machine learning model training data.

In some embodiments, the communication port(s) 512 couples the computing device 500 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 510 and/or the communication port(s) 512 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 514 may be any suitable display, and may display the user interface 516. The user interfaces 516 may enable user interaction with the annotated reference data and positional encodings identifying the location of each object of the plurality of objects of the reference image. For example, the user interface 516 may be a user interface for an application of a network environment operator that allows a user to view and interact with the operator's website. In some embodiments, a user may interact with the user interface 516 by engaging the input/output devices 508. In some embodiments, the display 514 may be a touchscreen, where the user interface 66 is displayed on the touchscreen.

The display 514 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

In some embodiments, the computing device 500 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 500 may be a computer, a workstation, a laptop, a server such as a cloud-based server, or any other suitable device. In some embodiments, the computing device 500 is a server that includes one or more processing units, such as one or more graphical processing units (GPUs), one or more central processing units (CPUs), and/or one or more processing cores. The computing device 500 may, in some embodiments, execute one or more virtual machines. In some embodiments, processing resources (e.g., capabilities) of the computing device 500 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

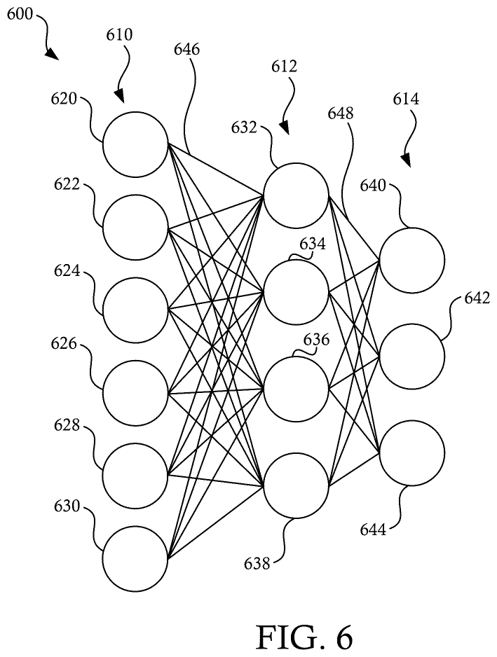

FIG. 6 illustrates a neural network 600, in accordance with some embodiments. Alternative terms for “neural network” are “artificial neural network,” “artificial neural net,” “neural net,” or “trained function.” The neural network 600 comprises nodes 620-644 and edges 646-648, wherein each edge 646-648 is a directed connection from a first node 620-638 to a second node 632-644. In general, the first node 620-638 and the second node 632-144 are different nodes, although it is also possible that the first node 620-638 and the second node 632-644 are identical. For example, in FIG. 6 the edge 646 is a directed connection from the node 620 to the node 132, and the edge 648 is a directed connection from the node 132 to the node 640. An edge 646-648 from a first node 620-638 to a second node 632-644 is also denoted as “ingoing edge” for the second node 632-644 and as “outgoing edge” for the first node 620-138.

The nodes 620-644 of the neural network 600 may be arranged in layers 610-614, wherein the layers may comprise an intrinsic order introduced by the edges 646-648 between the nodes 620-644 such that edges 646-648 exist only between neighboring layers of nodes. In the illustrated embodiment, there is an input layer 610 comprising only nodes 620-630 without an incoming edge, an output layer 614 comprising only nodes 640-644 without outgoing edges, and a hidden layer 612 in-between the input layer 610 and the output layer 614. In general, the quantity of hidden layer 612 may be chosen arbitrarily and/or through training. The quantity of nodes 620-630 within the input layer 610 usually relates to the quantity of input values of the neural network, and the quantity of nodes 640-644 within the output layer 614 usually relates to the quantity of output values of the neural network.

In particular, a (real) number may be assigned as a value to every node 620-644 of the neural network 600. Here,

$${x}_{i}^{( n )}$$

denotes the value of the i-th node 620-644 of the n-th layer 610-614. The values of the nodes 620-630 of the input layer 610 are equivalent to the input values of the neural network 600, the values of the nodes 640-644 of the output layer 614 are equivalent to the output value of the neural network 600. Furthermore, each edge 646-648 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 620-638 of the m-th layer 610, 612 and the j-th node 632-644 of the n-th layer 612, 614. Furthermore, the abbreviation

$${w}_{i , j}^{( n )}$$

is defined for the weight

$${w}_{i , j}^{( n , n + 1 )} .$$

In particular, to calculate the output values of the neural network 600, the input values are propagated through the neural network. In particular, the values of the nodes 632-644 of the (n+1)-th layer 612, 614 may be calculated based on the values of the nodes 620-638 of the n-th layer 610, 612 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 610 are given by the input of the neural network 600, wherein values of the hidden layer(s) 612 may be calculated based on the values of the input layer 610 of the neural network and/or based on the values of a prior hidden layer, etc.

In order to set the values

$${w}_{i , j}^{( m , n )}$$

for the edges, the neural network 600 has to be trained using training data. In particular, training data comprises training input data and training output data. For a training step, the neural network 600 is applied to the training input data to generate calculated output data. In particular, the training data and the calculated output data comprise a quantity of values, said quantity being equal with the quantity of nodes of the output layer.

In particular, a comparison between the calculated output data and the training data is used to recursively adapt the weights within the neural network 600 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers

$${δ}_{j}^{( n )}$$

may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on

$${δ}_{j}^{( n + 1 )} ,$$

it the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 614, wherein f^{x} is the first derivative of the activation function, and yⱼ⁽ⁿ⁺¹⁾ is the comparison training value for the j-th node of the output layer 614.

In some embodiments, the neural network 600 is implemented as convolutional neural network (CNN). The CNN is applied to the reference data. In some embodiments, a selected object and its features are inputted into the CNN, and the CNN outputs a plurality of feature embeddings. As described above, the feature extractor embeddings generated by the CNN are vector embeddings that represent the texture, edges, shape, patterns, or any other visually distinguishing feature of the selected object of the reference image.

It will be appreciated that localized embedding generation and image annotation, as disclosed herein, particularly with respect to large image datasets intended to be used with the disclosed embodiments, is only possible with the aid of computer-assisted machine-learning algorithms and techniques, such as a vector encoding models. Trained models may be used to perform operations that cannot practically be performed by a human, either mentally or with assistance, such as image annotation with the use of localized embeddings. It will be appreciated that a variety of machine learning techniques can be used alone or in combination to generate one or more machine learning models to generate positional encodings, feature embeddings, and object-specific cluster centroids.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a reference image including at least one annotated object;
generate at least one embedding representative of at least one feature of the at least one annotated object;
determine a dimension size of the at least one embedding, a vertical position maximum of the reference image, and a horizontal position maximum of the reference image;
determine a vertical position encoding and a horizontal position encoding for the at least one annotated object, wherein the vertical position encoding is determined based on the vertical position maximum of the reference image and the dimension size of the at least one embedding and the horizontal position encoding is determined based on the horizontal position maximum of the reference image and the dimension size of the at least one embedding;
combine the at least one feature embedding, the vertical position encoding, and the horizontal position encoding to generate a first cluster centroid for the at least one annotated object; and
identify an unannotated object in image data based on a comparison of the first cluster centroid and a second cluster centroid generated for the unannotated object.

2. The system of claim 1, wherein the vertical position encoding and the horizontal position encoding comprises position embeddings.

3. The system of claim 2, wherein combining the at least one feature embedding, the vertical position encoding, and the horizontal position encoding includes concatenating the at least one feature embedding, the vertical position encoding, and the horizontal position encoding.

4. The system of claim 1, wherein the reference image is a first image and the image data including the unannotated object is a second image.

5. The system of claim 1, wherein the image data including the unannotated object is the reference image.

6. The system of claim 1, where the instructions cause the processor to:
generate a second reference image from the image data including an annotation identifying the unannotated object as the at least one annotated object based on the comparison of the first cluster centroid and a second cluster centroid; and
identify a second unannotated object in second image data based on a comparison of the second cluster centroid and a third cluster centroid generated for the unannotated object based on the second reference image.

7. The system of claim 1, wherein the identification of the unannotated object in the image data is provided for training a computer vision task.

8. A computer-implemented method, comprising:
receiving a reference image including at least one annotated object;
generating at least one embedding representative of at least one feature of the at least one annotated object;
determining a dimension size of the at least one embedding, a vertical position maximum of the reference image, and a horizontal position maximum of the reference image;
determining a vertical position encoding and a horizontal position encoding for the at least one annotated object, wherein the vertical position encoding is determined based on the vertical position maximum of the reference image and the dimension size of the at least one embedding and the horizontal position encoding is determined based on the horizontal position maximum of the reference image and the dimension size of the at least one embedding;
combining the at least one feature embedding, the vertical position encoding, and the horizontal position encoding to generate a first cluster centroid for the at least one annotated object; and
identifying an unannotated object in image data based on a comparison of the first cluster centroid and a second cluster centroid generated for the unannotated object.

9. The computer-implemented method of claim 8, wherein the vertical position encoding and the horizontal position encoding comprises position embeddings.

10. The computer-implemented method of claim 9, wherein combining the at least one feature embedding, the vertical position encoding, and the horizontal position encoding includes concatenating the at least one feature embedding, the vertical position encoding, and the horizontal position encoding.

11. The computer-implemented method of claim 8, wherein the reference image is a first image and the image data including the unannotated object is a second image.

12. The computer-implemented method of claim 8, wherein the image data including the unannotated object is the reference image.

13. The computer-implemented method of claim 8, comprising:
generating a second reference image from the image data including an annotation identifying the unannotated object as the at least one annotated object based on the comparison of the first cluster centroid and a second cluster centroid; and
identifying a second unannotated object in second image data based on a comparison of the second cluster centroid and a third cluster centroid generated for the unannotated object based on the second reference image.

14. The computer-implemented method of claim 8, wherein the identification of the unannotated object in the image data is provided for training a computer vision task.

15. A non-transitory computer readable medium having instructions stored thereon, wherein the instructions, when executed by at least one processor, cause at least one device to perform operations comprising:
receiving a reference image including at least one annotated object;
generating at least one embedding representative of at least one feature of the at least one annotated object;
determining a dimension size of the at least one embedding, a vertical position maximum of the reference image, and a horizontal position maximum of the reference image;
determining a vertical position encoding and a horizontal position encoding for the at least one annotated object, wherein the vertical position encoding is determined based on the vertical position maximum of the reference image and the dimension size of the at least one embedding and the horizontal position encoding is determined based on the horizontal position maximum of the reference image and the dimension size of the at least one embedding;
combining the at least one feature embedding, the vertical position encoding, and the horizontal position encoding to generate a first cluster centroid for the at least one annotated object; and
identifying an unannotated object in image data based on a comparison of the first cluster centroid and a second cluster centroid generated for the unannotated object.

16. The non-transitory computer readable medium of claim 15, wherein the vertical position encoding and the horizontal position encoding comprises position embeddings.

17. The non-transitory computer readable medium of claim 16, wherein combining the at least one feature embedding, the vertical position encoding, and the horizontal position encoding includes concatenating the at least one feature embedding, the vertical position encoding, and the horizontal position encoding.

18. The non-transitory computer readable medium of claim 15, wherein the reference image is a first image and the image data including the unannotated object is a second image.

19. The non-transitory computer readable medium of claim 15, wherein the image data including the unannotated object is the reference image.

20. The non-transitory computer readable medium of claim 15, wherein the instructions cause the at least one device to perform operations comprising:
generating a second reference image from the image data including an annotation identifying the unannotated object as the at least one annotated object based on the comparison of the first cluster centroid and a second cluster centroid; and
identifying a second unannotated object in second image data based on a comparison of the second cluster centroid and a third cluster centroid generated for the unannotated object based on the second reference image.
